(19) United States
(12) Patent Application Publication
(10) Pub. No.: US 2019/0111451 A1
(43) Pub. Date: Apr. 18, 2019

(54) METHOD AND DEVICE FOR COATING INDIVIDUAL SHEETS

(71) Applicant: Argos Solutions SCRL, Enghien (BE)

(72) Inventor: Tony Michiels, Enghien (BE)

(21) Appl. No.: 15/911,603

(22) Filed: Mar. 5, 2018

(30) Foreign Application Priority Data
Oct. 13, 2017 (BE) 2017/5733

(51) Int. Cl. B05D 3/02; B05D 3/06; B05D 7/04; B05D 1/28

(52) U.S. Cl. CPC B05D 3/0209; B05D 1/28; B05D 7/04; B05D 3/067

(57) ABSTRACT

In a first aspect, the invention concerns a method for providing a varnish coating to individual sheet substrates, said method comprising the steps of applying a liquid coating composition to the upper surface of a sheet substrate, conveying said sheet substrate along a track, while supporting the substrate from its rear surface, and subsequently curing and/or drying said coating composition. In particular, the aforementioned track is at least partly curved. In a second aspect, the invention relates to a device for performing such a method.

### CROSS-REFERENCE TO RELATED APPLICATION

Pursuant to 35 U.S.C. § 119(a), this application claims the benefit of earlier filing date and right of priority to Belgian patent application no. BE2017/5733, filed on Oct. 13, 2017, the contents of which are hereby incorporated by reference herein in the entirety.

### TECHNICAL FIELD

The invention generally relates to the technical field of applying coatings to individual sheet substrates; and, more particularly, the invention relates to the provision of varnish coatings to individual paper sheets.

### BACKGROUND

Methods and devices for applying varnish coatings to substrates are known in the art. Reference is made, for instance, to U.S. Pat. Nos. 3,356,064, 4,947,745, and 4,928,623. These methods may comprise the steps of: (1) applying a layer of liquid varnish to a substrate, and (2) curing/drying the layer. A varnish coating is ultimately obtained.

The quality of the coating may be evaluated on, among other things, the coating's transparency, its uniformity, its degree of coverage, its surface-weighed cost, its resistance to soiling (e.g. its ink absorbency), its surface gloss, its smoothness, and/or its mechanical properties (e.g. its strengthening, anti-scratch and slippage properties, and its adhesion to the substrate). There may be additional requirements concerning the ease of application of the liquid varnish (related to e.g. its wetting capability), and concerning the amount of time required for curing the liquid varnish. The additional requirements may be in particular with regard to scalability.

It has been observed, however, that varnish coatings as obtained via any of the above methods do not have a high-gloss, or a “perfectly flat” surface. Rather, their surface may feature a patterned relief that can be felt when touched, and that can even be seen with the naked eye. This is highly undesirable.

As further examples, U.S. Pat. No. 5,429,349 discloses an apparatus for buffering the transport of freshly inked documents, while U.S. Pat. No. 5,667,213 relates to a small-size-sheet stacking unit.

The present invention aims to provide a novel method and device for applying varnish coatings to substrates. Preferably, these coatings have a smooth surface, featuring high surface gloss values.

### SUMMARY OF THE INVENTION

In a first and second aspect, the present invention respectively discloses a method and a device for providing a varnish coating to a sheet substrate.

According to a non-limiting embodiment of the invention, a method is provided for applying a varnish coating to an individual sheet substrate that has an upper surface and a rear surface, the method comprising: applying, by a coating application unit, a coating composition to the upper surface of the sheet substrate; conveying, by a substrate conveying system, said sheet substrate along a track that runs from the coating application unit to a curing unit 4, wherein the substrate conveying system supports the sheet substrate from its rear surface; and curing and/or drying, by the curing unit, said coating composition, wherein the curing unit comprises one or more energy emitting sources, characterized in that said track is at least partly curved.

The track can have a track length that is longer than the shortest distance between the coating application unit and the curing unit.

The track can have at least one segment that is sloped.

The track can have at least one segment that is twisted.

The track can pass by two or more positions for the sheet substrate, wherein the two or more positions can lie vertically above one another.

The track can be continuous.

The track can include a spiral track.

The track can have a maximum slope of less than 30%.

The track can have a maximum curvature and/or torsion of less than 20 rad/m.

The track length can be between 20 cm and 50 m.

The coating composition can be at least partly sprayed onto the upper surface of the sheet substrate.

According to a non-limiting embodiment of the invention, a device is provided for applying a coating to an individual sheet substrate that has an upper surface and a rear surface, said device comprising: a coating application unit that applies a coating composition to the upper surface of the sheet substrate; a curing unit that comprises an energy source that emits energy having a predetermined wavelength to cure and/or dry said coating composition; and a substrate conveying system that transports said sheet substrate from said coating application unit to said curing unit, characterized in that said substrate conveying system comprises a curved conveyor. The curved conveyor can comprise a spiral conveyor, characterized in that said spiral conveyor comprises a slat. The curing unit can comprise one or more LEDs. The device can have a modular structure. The conveying system can be a module. The coating application unit can be a module. The curing unit can be a module. At least one of a speed and a track length of the conveyor can be selected to control a dwell-time of the sheet substrate. The coating application unit can comprise a spraying system.

According to an aspect of the invention, the sheet substrate can be conveyed along a track that is at least partly curved. The track can run from the coating application unit to the curing unit, and can be realized by means of substrate conveying system that supports the substrate from its rear surface. As a result, a dwell time for the substrate can be introduced, in between the step of applying the liquid coating composition and the step of actively curing and/or drying the latter. By, thereby, controlling the dwell time, the quality of the varnish coating is largely improved. For instance, its surface will feature higher specular reflection gloss values.

The invention provides the added benefit of not needing a temporary stock of freshly coated substrates that await drying/curing. The coated substrates, rather, remain in motion, whereby the aforementioned substrate conveying system acts as a non-disruptive buffering system. As such, the continuity of the process flow is ensured. The track can be at least partly curved, and is thereby preferably as compact as possible. As a consequence, less floor space is required.

### DESCRIPTION OF FIGURES

FIG. 1 shows a perspective view of a coating device according to an embodiment of the invention.

FIGS. 2A and 2B show sections of curved slat conveyors, according to embodiments of the coating device.

FIGS. 3A and 3B show respective schematic views of a continuously and a discontinuously meandering substrate conveying system, according to embodiments of the invention.

FIGS. 4A and 4B show, respectively, a perspective view and a top view of a substantially spiral substrate conveying system, according to an embodiment of the invention.

### DETAILED DESCRIPTION OF THE INVENTION

The invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention. Moreover, it is noted that like reference numerals represent similar parts throughout the several views of the drawings.

The present invention relates to a method and a device for providing a coating to a substrate. The coating can include a resin, a varnish, a lacquer, a shellac, a finish, a glaze, a paint, and the like, that can be applied to, deposited on, or otherwise affixed to the substrate. The substrate can include one or more individual sheets of substrate.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise.

“About” as used herein referring to a measurable value such as a parameter, an amount, a temporal duration, and the like, is meant to encompass variations of +/− 20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specify the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Throughout this document, it is specified that the substrates have “an upper surface” and “a rear surface”, which is only a matter of definition. The upper surface is the substrate surface to which a coating is currently applied, its opposite surface thereby being the rear surface. Of course, it may be possible in subsequent steps to equally provide a varnish coating to the rear surface of the substrate. This may be done in accordance with the present method, or alternatively according to any other, suitable coating technique.

In a first aspect, the present invention discloses a method for providing a varnish coating to individual sheet substrates, which substrates have an upper and a rear surface, said method comprising the steps of:
applying a liquid coating composition to the upper surface of a sheet substrate, by means of a coating application unit,
conveying said sheet substrate along a track that runs from said coating application unit to a curing unit, by means of a substrate conveying system that supports the substrate from its rear surface, and
curing and/or drying said coating composition by means of said curing unit, which curing unit comprises a source of light and/or heat.

In particular, said track is at least partly curved.

Any known coating composition can be employed in conjunction with the present method. The coating composition can be in a liquid, a powder, or any other suitable form that can be applied to the substrate, without the departing from the scope or spirit of the invention. For instance, the coating composition can comprise a liquid coating composition such as, for example, a water-based, solvent-based (e.g. comprising oil and/or alcohol) and/or UV-curable composition. The liquid coating composition may give rise to a varnish finishing layer. Alternatively (or additionally), the liquid coating composition can include a primer composition, as a preparation for further varnishing/printing layers or steps. Furthermore, the step of curing and/or drying the composition can be performed via hot air, and/or via UV-, Vis- and/or IR-irradiation. The curing unit is designed accordingly. In fact, the liquid coating composition may already be partially dried or cured, prior to arriving at the curing unit. For instance, such a partial drying/curing can take place during its transferal from the coating application unit towards the curing unit.

In any case, the exact implementation of the method will depend on the type of varnish employed, and on the type of substrate material.

The coating composition may be applied to the substrate via an applicator roll, via a spraying system, via an inkjet system, and/or via any other technique known in the field of paper/substrate treatment and handling. It is thereby possible to select a suitable deposition technique according to the situation at hand. The coating application unit is designed accordingly. It is possible, for instance, to apply a layer of coating composition that covers the entire substrate upper surface. On the other hand, selective coating techniques (e.g. selective coating or spot coating) may be envisaged for precisely and selectively providing a varnish coating, only to one or multiple, well-defined regions on the substrate surface.

In general, the consumption of coating composition typically ranges between 1 g/m² and 50 g/m². Preferably however, a minimum amount of coating composition suffices for the purpose of obtaining a high quality coating. In this respect, the coating composition (e.g., varnish) consumption most preferably ranges from 2 g/m² to 3 g/m². By preference, the surface-weighed cost of the coating is as low as possible.

The varnish coating is preferably transparent, with opacity values below 25%, more preferably below 20%, more preferably below 15%, more preferably below 10%, more preferably below 5%. Preferably, the varnish coating uniformly covers the substrate surface, or at least one or more regions thereof, in case of selective coating. It is thereby preferred that the coating thickness varies ±20% at most, and preferably less than ±10%, more preferably less than ±5%. Preferably, the varnish coating offers a good resistance to soiling, while featuring high smoothness and surface gloss values. The specular reflection gloss of the obtained varnish coating, as measured in accordance with ASTM D523, is preferably above 20 GU (Gloss Units), more preferably above 30 GU, more preferably above 40 GU, more preferably above 50 GU, more preferably above 60 GU, more preferably above 70 GU, and more preferably above 80 GU, at a measurement angle of 20°.

It is further preferred that the varnish coating significantly strengthens the substrate, while having a good adherence to the substrate. Furthermore, the varnish coating may advantageously seem to improve the print quality, and in particular the deepness and contrast of a printed substrate, as perceived when looking through the (transparent) layer of the varnish coating.

It has been observed that, in at least one of the above-mentioned respects, the quality and performance of the varnish coating is largely improved when introducing a dwell time (i.e. a retention time) for the substrate, in between the step of applying the liquid coating composition and the step of actively curing and/or drying latter composition.

More specifically, it has been noted that the optimal dwell time ranges from a few seconds to a few hundreds of seconds, depending on the geometry, and on the nature of the substrate (in particular its absorbency) and the varnish (in particular its viscosity and flowability). Preferably, said dwell time is between 2 seconds and 200 seconds; more preferably it is less than 150 seconds, more preferably less than 100 seconds, more preferably more than 5 seconds, more preferably less than 75 seconds, and more preferably between 5 seconds and 50 seconds. For instance, said dwell time may equal about 5 seconds, 15 seconds, 20 seconds, 30 seconds, 40 seconds, 50 seconds, or any value therebetween.

According to a first mechanism, during said dwell time, the liquid coating composition can redistribute onto the substrate. As such, its degree of flatness and/or its uniformity can be increased. On a local level, this can further improve the smoothness and surface gloss values of the ultimate (or final) coating. Generally speaking, when providing a dwell time, less amount of the liquid varnish composition is required for obtaining a varnish coating that performs at least as good in terms of flatness, uniformity, smoothness, and surface gloss. In some cases, varnish coatings of superior quality may therefore even be obtained with liquid varnish consumptions as low as 2 to 3 g/m². The above-mentioned redistribution can result from adhesion-driven, cohesion-driven, and/or gravity-driven flow of the liquid coating composition. The extent to which this mechanism unfolds can depend on, amongst other things, the substrate surface roughness, the viscosity and flowability of the liquid varnish, and/or on the volatility of one or more of its components.

According to a further mechanism, during said dwell time, the liquid coating composition at least partly penetrates into the substrate. As a consequence, the resulting coating has a better adherence to the substrate. This can improve the mechanical properties of the coated substrate. The mechanism can be largely influenced by the absorbency of the substrate surface, and by the viscosity of the liquid coating composition.

According to yet another mechanism, any voids that are formed or develop in the coating during its application step, may collapse or may at least diminish in size during said dwell time. This is highly advantageous, since such voids typically act as light scattering centers, decreasing the transparency (i.e. increasing the opacity) of the varnish coating. Additionally, the resulting coating will be denser and stronger, such that the mechanical properties of the coated substrate are improved. Furthermore, any surface voids (located at the upper coating surface) may collapse or diminish in size, such that the resulting coating is less prone to soiling, and has higher gloss values. Moreover, any interface voids (located at the substrate-coating interface) may collapse or diminish in size. The adherence to the substrate will thereby further be increased.

In most cases, the effect of the above mechanisms will be more pronounced as the dwell time increases. Other considerations for adequately selecting a suitable dwell time may relate to, amongst others, the area-efficiency and time-efficiency of the coating process, the quality to be achieved, the specifics of the substrate and the liquid coating composition, the risk of soiling the freshly applied, non-cured coating, and the optionally unwanted evaporation of one or more, volatile components thereof.

The aforementioned track advantageously can correspond to a dwell time that is granted to the freshly coated substrates, prior to them being dried and/or cured. This dwell time, thus, in turn, corresponds to a track to be followed by the sheet substrates, in between the varnish application unit and the drying/curing unit. Said track has a track length, and thus a dwell time associated thereto. The actual dwell time depends on the speed at which the substrates traverse said track.

The track itself can be realized by means of a substrate conveying system. This system may comprise a chain conveyor, a belt conveyor, a plate link conveyor, a slat conveyor, a string conveyor, a roller conveyor, and/or any other, suitable type of conveyor that is known in the field. In this regard, it should be emphasized that individual sheet substrates (e.g. single paper sheets) may require specific handling, different from handling web substrates (e.g. paper rolls). For instance, considerable lengths of web can be stretched between, and redirected about configurations of rollers. Sheet substrates, on the other hand, can be handled individually. Moreover, the conveying system of the present method can be configured for supporting the substrate from its rear surface, and preferably from its rear surface solely. Its freshly coated, upper surface is thereby preferably not interfered with. As such, a high quality coating can be obtained. It is further preferred that the substrate is not supported from its side edges, such that these edges remain undamaged. Most preferably, the substrates are cut sheet paper substrates.

In order to occupy an equipment footprint area that is as compact as possible, the abovementioned “track” should at least have a specific form. For instance, the track can be folded or wrapped-up. Preferably, said track is at least partly curved. In further or alternative embodiments, the track is discontinuously segmented.

The track can mathematically be approximated by a “space-curve”. For instance, space-curve can include the locus (which is a mathematical term) of a central point of a substrate being conveyed along said track. In this regard, “curved” should be understood as there being at least one point along the aforementioned space-curve, in which the curvature and/or torsion of said curve is nonzero. In a non-limiting embodiment, the track is continuously meandering in a horizontal plane (e.g. sinuously or serpentine). The track thereby features a plurality of alternately curved curvatures. “Discontinuously segmented”, on the other hand, should be understood as there being at least one point along the space-curve, in which the tangent to said curve is discontinuous. Latter point is the boundary point connecting two neighboring track segments. A “discontinuously segmented track” thus comprises two or more of such segments, having different (e.g. mutually orthogonal) segment directions at their boundary points.

In any case, a “conveying step” is advantageously incorporated into the method. In doing so, it is possible to install and/or adjust a dwell time, without requiring the provision of a temporary stock of freshly coated substrates that await drying/curing. The coated substrates rather remain in motion, whereby the substrate conveying system acts as a non-disruptive buffering system. As such, the continuity of the process flow is ensured. The application of the liquid coating composition to further substrates is not obstructed: subsequent to the coating application step, the freshly coated substrates are evacuated from the coating application unit. The track is preferably as compact as possible, as a consequence of it being at least partly curved. The area-efficiency of the coating process is thereby increased.

In a further or alternative embodiment, the track is continuous. It is thereby preferred that the substrates do not abruptly change direction, along the length of the track. Instead, the track is smoothly curved, which enables a continuous substrate flow. Through the provision of curves, said track can nevertheless be folded or wrapped-up into a compact geometry.

Sheet buffering systems reminiscent of vertical elevator systems are known in the field of printing technology. U.S. Pat. No. 5,429,349, for instance, discloses an apparatus for buffering the transport of freshly inked documents. It has conical screws, and it thereby provides a plurality of successive floors/stories, into which individual sheet substrates can be buffered while being transported upwardly. Clearly, such systems are discontinuous substrate conveying systems; the substrates change from a horizontal direction of movement (upon their insertion) into a vertically upward direction of movement. Furthermore, such conveying systems require a careful alignment of the screws with the substrate to be inserted. This results in a discontinuous and possibly disruptive substrate flow. Moreover, the conical screws rub against the substrate side edge regions. These edge regions may thus get damaged. It is further believed that system of this kind can only be applied in case the substrate is sufficiently small and rigid, since otherwise it would sag. Indeed, the substrates are only supported from their side edges. A comparable system is disclosed in U.S. Pat. No. 5,667,213.

The present method can also be applied to relatively large and flexible substrates. Preferably, in this regard, the track is continuous, and therefore non-disruptive.

According to a further or alternative embodiment, the track is at least partly curved and/or segmented. In a non-limiting embodiment, the track is discontinuously segmented, in that it comprises at least one point where the substrate discontinuously changes direction.

According to a further or alternative embodiment, the track has a track length, which track length is longer than the shortest distance between the coating application unit and the curing unit. This allows for the provision of a relatively long track, corresponding to a sufficiently long dwell time. At the same time, since the track is folded or wrapped up, the coating application unit can nevertheless be arranged near the curing unit, such that the overall dimensions of the device are only moderate.

Preferably, said track length is at least twice as long, and more preferably, said track length is at least three times as long. Preferably, the track is as compact as possible, in terms of its overall dimensions.

According to a further or alternative embodiment, said track comprises at least one segment that is sloped. The length of such a sloped track segment is larger than the horizontal distance that is spanned by that segment. Sloped track segments are thus more efficient in terms of occupied floor space. In a non-limiting embodiment, the track comprises a plurality of successive, sloped segments that are interconnected via bent segments. According to a further or alternative embodiment, said track comprises at least one segment that is twisted. Such a segment is both bent and sloped. Since it is at least sloped, a similar advantage applies.

According to a further or alternative embodiment, the track passes by two or more positions for the substrate, which positions lie vertically above one another. Less floor space is required: the height of the coating hall is more efficiently exploited, by means of tracks that vertically overlap. According to a further or alternative embodiment, the track comprises a repetitive scheme of two or more, substantially identical track sections. These track sections are installed above one another, while connecting to each other. Again, the height of the coating hall is efficiently exploited, and less floor space is required. Moreover, such geometries are particularly simple. Preferably, the track is continuous.

According to a further or alternative embodiment, the track comprises a spiral. The track thereby preferably comprises a repetitive scheme of identical, twisted track sections that are installed above one another and that connect to each other. The track may be spiraling upwards or downwards, in which the same effect is obtained. The axial projection of the spiraling track may be circular, yet it can equally have a non-circular form, such as a (rounded) square or rectangle, or any other suitable form.

Any friction between the substrate rear surface and the substrate conveying system will mostly take place in case of changes in track curvature and/or torsion. In a further or alternative embodiment, the track thus comprises a circular spiral featuring a constant curvature and torsion. Once the substrate enters this twisted spiral form, the curvature and torsion are thus not altered until it exits the spiral. Quite advantageously, the freshly coated substrate is thus granted a dwell time, without being subjected to changing curvatures and/or torsion.

According to a further or alternative embodiment, the track has a maximum slope of less than 30%. In other words, the local slope between any two adjoining points along the track never exceeds 30%. The maximum slope is preferably less than 25%, more preferably less than 20%, and more preferably less than 15%. As a result, the substrate will not start sliding along sloped sections of said track, even in case the substrate conveying system is provided with a low-friction bearing surface. Moreover, the substrate conveying system is preferably provided with such a low-friction bearing surface, for supporting the substrate rear surface. As a consequence, mutual friction is minimal, and there is less risk on damaging the substrate rear surface. The static coefficient of friction is preferably less than 0.5, more preferably less than 0.4, more preferably less than 0.3, and more preferably less than 0.2, and more preferably less than 0.1. Preferably however, the static coefficient of friction is more than 0.01, such that the substrates do not start sliding along sloped track sections. Since the maximum track slope is less than 30%, the upper substrate surface can be facing substantially upwards at all times—i.e., the zenith angle of its normal is less than 45°.

According to a further or alternative embodiment, the track has a maximum curvature and/or torsion of less than 20 rad/m. Preferably, the maximum torsion is less than 20 rad/m. Preferably, the maximum curvature is less than 20 rad/m.

According to a further or alternative embodiment, the track length is between 20 cm and 50 m. Preferably, the track length is less than 40 m, preferably less than 30 m, preferably more than 30 cm, preferably more than 40 cm, preferably more than 50 cm, preferably less than 20 m. The corresponding dwell time depends on the speed at which the substrate is conveyed. The dwell time, thus, for instance, can be adjusted by adjusting this speed.

Optionally, at least parts of the substrate conveying system can vibrate when transporting a substrate, at frequencies between 5 Hz and 10 kHz, preferably below 5 kHz.

The above method is preferably employed for sequentially coating a plurality of substrates. The substrate conveying system may thus simultaneously convey a plurality of freshly coated substrates, along its overall length.

In a further or alternative embodiment, the liquid coating composition is at least partly sprayed onto said upper surface. To date, such spraying systems cannot be employed in providing high-quality varnish coatings to individual paper sheet substrates. In particular, it is not possible to obtain the high smoothness and specular surface gloss values mentioned above, since the freshly sprayed layer of liquid coating composition is not uniform/smooth enough to start with. By use of the present method, however, the substrates are granted a dwell time, prior to being dried/cured. As such, the freshly sprayed layer has some time to “flow”, whereby it is redistributed onto the surface. As such, a varnish layer of high smoothness, and featuring high specular surface gloss values can nevertheless be obtained. An additional advantage of spraying systems is that they require less maintenance than, for instance, an applicator roll and/or doctor blade. Moreover, they are typically less expensive than an inkjet system. Furthermore, it is a faster technique for uniformly coating individual sheet substrates. Of course, and in line with what is mentioned above, any other technology for applying the liquid coating composition may alternatively or additionally be employed.

In a second aspect, the present invention discloses a device for providing a coating to individual sheet substrates, which substrates have an upper surface and a rear surface, said device comprising:
a coating application unit, for applying a liquid coating composition to the upper surface of a sheet substrate,
a curing unit, which curing unit comprises a source of light and/or heat, for curing and/or drying said coating composition, and
a substrate conveying system, for conveying said substrate from said coating application unit to said curing unit;

In particular, said substrate conveying system comprises a spiral conveyor. Said device is preferably configured for performing the method according to the first aspect of the invention. The spiral conveyor may be coiling upwards and/or downwards. The substrate conveying system may further comprise a plurality of such spiral conveyors, coiling upwards and/or downwards. The device may be provided with substrate detection sensors for full sheet tracking. In a further or alternative embodiment, said spiral conveyor is a slat conveyor, thus comprising slats.

In a further or alternative embodiment, said curing unit comprises one or more LEDs. The advantages of LED curing are a lower power consumption, a maximum uptime of the machines, a constant quality, a full digital intensity control, no thermal disturbance of the paper, a virtually maintenance free technology, avoiding ozone health risk, no use of mercury, and that there is no need for cooling and/or extraction of hot air. Of course, in line with what is mentioned above, any other technique for drying and/or curing the freshly applied liquid coating composition may alternatively or additionally be employed. For instance, the curing unit can alternatively or additionally comprise a conventional UV-bulb curing system.

In a further or alternative embodiment, the device has a modular structure, said conveying system and/or one or more of said units being modules. The device can be applied inline to (digital) printers, and/or offline, having its own substrate feeders, and optionally having its own substrate stackers. In an inline configuration, the device is preferably provided with communication hardware, enabling a smooth process flow and a centralized control. The device may further comprise a feeding unit, a creasing unit, and/or a stacking unit.

In a further or alternative embodiment, said coating application unit comprises a spraying system. The advantages as set out above, in relation to the coating method. Of course, in line with what is mentioned above, any other technology for applying the liquid coating composition may alternatively or additionally be employed. The coating application unit is then designed accordingly.

In a third aspect, the present invention relates to a device, configured for performing the method according to the first aspect of the invention. Preferably, said device comprises the layer application unit, the substrate transfer unit, and the curing unit.

The invention is further described by the following, non-limiting examples and figures that further illustrate the invention, and that are not intended to, nor should they be interpreted to, limit the scope of the invention.

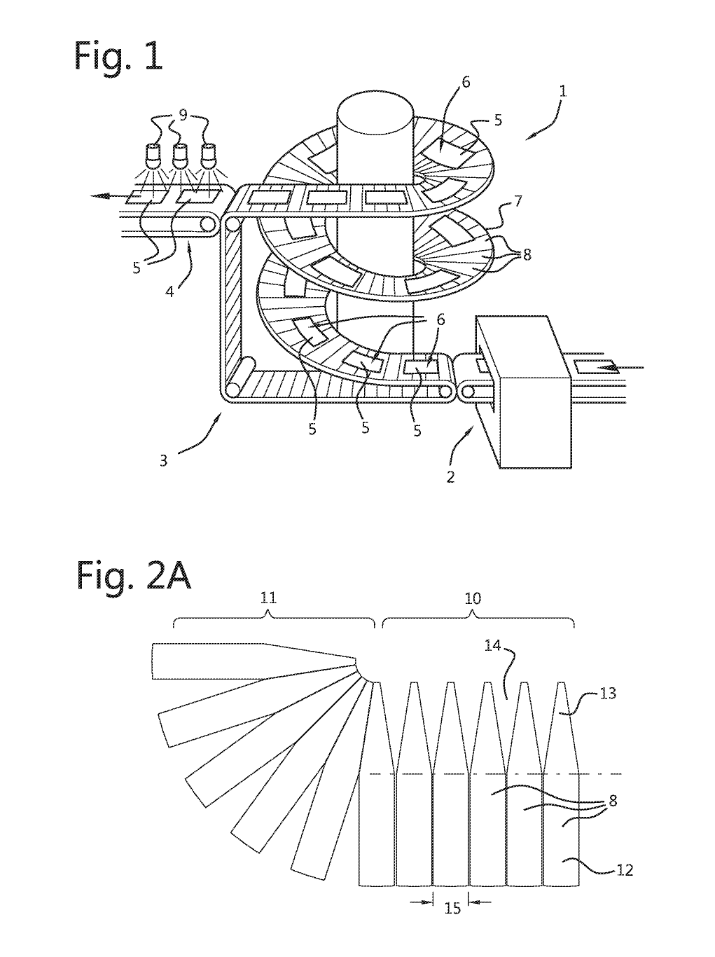

FIG. 1 shows a perspective view on an inline coating device 1 according to an embodiment of the invention. The coating device 1 comprises a coating application unit 2, a substrate conveying system 3, and a curing unit 4.

In the coating application unit 2, a layer of liquid coating composition is provided to an upper (or first) surface 5 of one or more substrates 6. For instance, the substrates 6 can stem from a digital printer (not shown) installed upstream along the printing-coating line. Subsequently, the substrates 6 can be conveyed in a first direction (e.g., upwards), towards the curing unit 4, by means of the conveying system 3.

The conveying system 3 comprises a conveyor 7, which can be a circular, spiral conveyor having, for example, approximately two windings, a slat conveyor, or any other type of conveying mechanism that is capable of transferring the substrate(s) 6 from the coating application unit 2 to the curing unit 4. The conveyor 7 can comprise a plurality of slats 8. The substrates 6 can be provided with a dwell time. Their upper surface 5 can be facing substantially upwards at all times.

In terms of occupied floor space (or “footprint”), the substrate conveying system 3 can be as compact as an elevator system (not shown) that is designed to receive the substrates 6 and transport the substrates from the coating application unit 2 to the curing unit 4 in a vertical (or horizontal) direction. The conveying system 3 can be advantageous in that the flow of logistics is not disrupted, while nevertheless sustaining a considerable track length. As can be seen in the figure, the coating application unit 2 and the curing unit 4 can be installed at a different height with respect to each other.

The curing unit 4 includes one or more energy sources (or energy emitting devices) 9 for curing the layer of liquid coating composition. The energy emitting device(s) 9 can include light emitting diodes (LEDs). The energy emitting devices 9 can emit, for example, ultraviolet (UV) wavelengths, visible wavelengths, infrared wavelengths, low energy electrons, and the like. The coated substrates 6 can subsequently be handed over to additional units/devices/modules (not shown) that can be provided downstream of the coating device 1, for instance to a stacking unit/device/module (not shown).

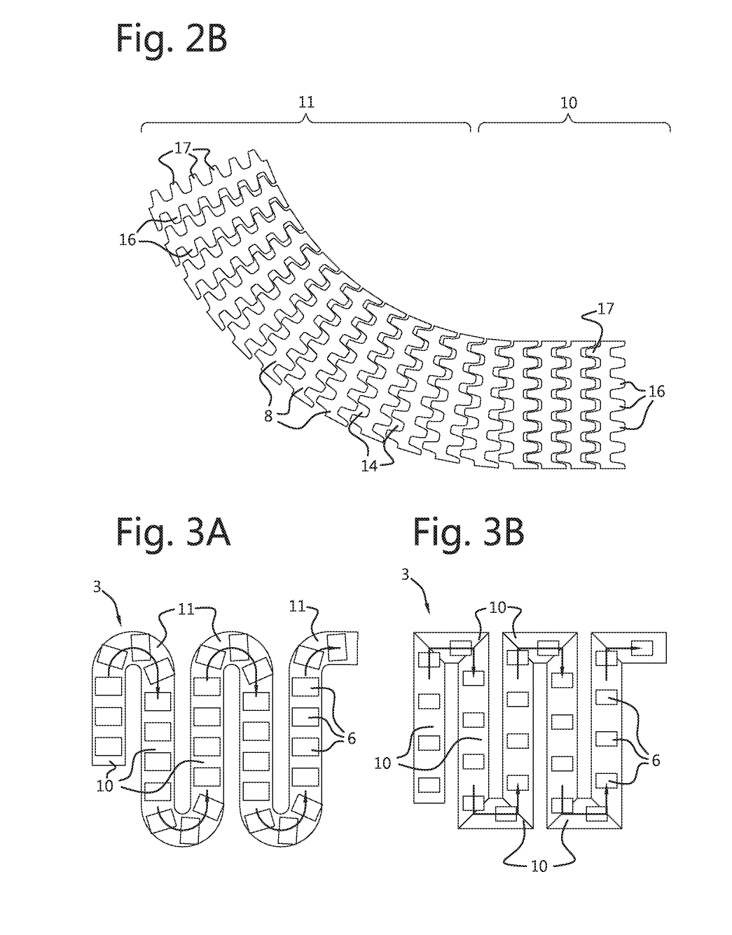

FIGS. 2A and 2B show straight 10 and bent 11 track sections of a curved slat conveyor, according to embodiments of the current device 1. The track sections 10, 11 can continuously connect to each other, while extending in the same plane. The related torsion can thus be equal to, or about zero.

In the embodiment of FIG. 2A, the slats 8 comprise a rectangular arm 12 and a trapezoid arm 13, axially extending from each other, and reflection-symmetric about the axis in question. As such, the slat conveyor is able to curve in one direction. The trapezoid arms 13 form one or more inter-slat gaps 14 in track section 10. The inter-slat gap 14 does thereby not exceed the slat width 15. Similar slats 8 featuring two trapezoid arms 13 (and optionally a rectangular body) may be envisaged; such slats 8 would be able to curve in two directions.

In the embodiment of FIG. 2B, the slats 8 comprise at one side a plurality of fingers 16, while comprising at their opposite side receptacles 17 corresponding thereto. As a result, any inter-slat gap 14 is substantially meandering, such that the risk on substrates 6 falling through is reduced. Of course, other types of slat conveyors are envisaged, such as, for instance, feature slats 8 that at least partly overlap. In such instances, there would be little or no inter-slat gap 14 at all. The risk on substrates 6 falling through is then further reduced, and device safety can be further improved by preventing articles or objects from getting between the fingers 16 and receptacles 17.

FIG. 3A shows a schematic view of a substrate conveying system 3 that continuously meanders, according to an embodiment of the invention. The corresponding track 10, 11 runs in one and the same plane, such that the torsion is equal to, or about zero. The conveying system 3 comprises a number of successive straight track sections 10 and bent track sections 11 that continuously connect to each other.

FIG. 3B shows a schematic view of a discontinuously meandering, segmented substrate conveying system 3. The corresponding track 10, 11 again runs in one and the same plane, such that the torsion is equal to, or about zero. The conveying system 3 comprises a plurality of segments, each of which corresponds to a straight track section 10. The plurality of segments can comprise successively orthogonal segments.

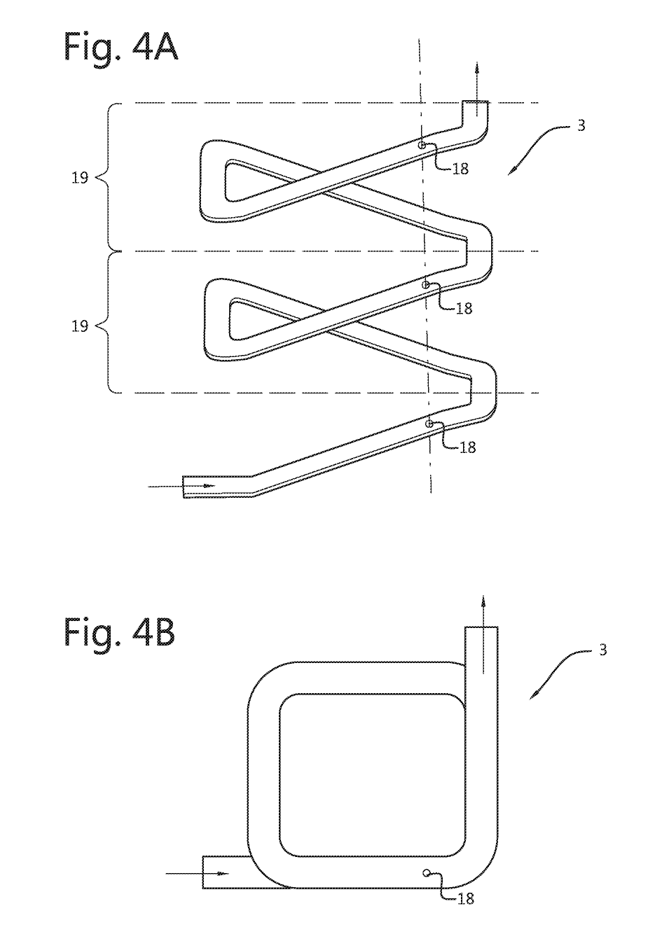

FIGS. 4A and 4B show, respectively, a perspective view and a top view of a substantially spiral substrate conveying system 3, according to an embodiment of the invention. In the top view (shown in FIG. 4B), it can be seen that the track can have a non-circular, rounded-square, upward spiraling form. In particular, the track can pass by two or more positions 18 for the substrate 6, which lie vertically above one another. Furthermore, the track can comprise a repetitive scheme of at least two, substantially identical, spiral track sections 19. The track sections 19 can be installed above one another, while continuously connecting to each other. Such geometries can be particularly simple.

While the invention has been described in terms of exemplary embodiments, those skilled in the art will recognize that the invention can be practiced with modifications in the spirit and scope of the appended claims. These examples are merely illustrative and are not meant to be an exhaustive list of all possible designs, embodiments, applications, or modifications of the invention.

1. A method for providing a varnish coating to an individual sheet substrate that has an upper surface and a rear surface, the method comprising:
applying, by a coating application unit, a coating composition to the upper surface of the sheet substrate;
conveying, by a substrate conveying system, said sheet substrate along a track that runs from the coating application unit to a curing unit 4, wherein the substrate conveying system supports the sheet substrate from its rear surface; and
curing and/or drying, by the curing unit, said coating composition, wherein the curing unit comprises one or more energy emitting sources,
characterized in that said track is at least partly curved.

2. The method according to claim 1, characterized in that said track has a track length that is longer than the shortest distance between said coating application unit and said curing unit.

3. The method according to claim 1, characterized in that said track comprises at least one segment that is sloped.

4. The method according to claim 1, characterized in that said track comprises at least one segment that is twisted.

5. The method according to claim 1, characterized in that said track passes by two or more positions for the sheet substrate, wherein said two or more positions lie vertically above one another.

6. The method according to claim 1, characterized in that said track is continuous.

7. The method according to claim 1, characterized in that said track comprises a spiral.

8. The method according to claim 1, characterized in that said track has a maximum slope of less than 30%.

9. The method according to claim 1, characterized in that said track has a maximum curvature and/or torsion of less than 20 rad/m.

10. The method according to claim 1, characterized in that said track length is between 20 cm and 50 m.

11. The method according to claim 1, characterized in that said coating composition is at least partly sprayed onto said upper surface.

12. A device for providing a coating to an individual sheet substrate that has an upper surface and a rear surface, said device comprising:
a coating application unit that applies a coating composition to the upper surface of the sheet substrate;
a curing unit that comprises an energy source that emits energy having a predetermined wavelength to cure and/or dry said coating composition; and
a substrate conveying system that transports said sheet substrate from said coating application unit to said curing unit,
characterized in that said substrate conveying system comprises a curved conveyor.

13. The device according to claim 12, wherein the curved conveyor comprises a spiral conveyor, characterized in that said spiral conveyor comprises a slat.

14. The device according to claim 12, characterized in that said curing unit comprises one or more LEDs.

15. The device according to claim 12, characterized in that said device has a modular structure.

16. The device according to claim 15, wherein conveying system is a module.

17. The device according to claim 15, wherein the coating application unit is a module.

18. The device according to claim 15, wherein the curing unit is a module.

19. The device according to claim 12, wherein at least one of a speed and a track length of the conveyor is selected to control a dwell-time of the sheet substrate.

20. The device according to claim 12, characterized in that said coating application unit comprises a spraying system.
